(19) United States
(12) Patent Application Publication
(10) Pub. No.: US 2006/0074918 A1
(43) Pub. Date: Apr. 6, 2006

(54) Method and accelerating data search for data archive system

(76) Inventors: Daiki Nakatsuka, Yokohama (JP); Kenta Shiga, Yokohama (JP); Mitsuru Ikezawa, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/995,414

(22) Filed: Nov. 24, 2004

(30) Foreign Application Priority Data
Sep. 30, 2004 (JP) 2004-286331

(51) Int. Cl. G06F 17/30

(52) U.S. Cl. 707/10

(57) ABSTRACT

In a data archive system, a time necessary for to processing a search task is shortened. A data archive system according to this invention includes: a storage apparatus including plural volumes in which data is stored; plural search servers which process a search task which requests a search for desired data; and a management server that includes a CPU, an interface, and a memory and manages the search servers, in which the management server has a table adapted to manage the data stored in the volumes, obtains load information concerning the search servers, selects each of the search servers, which is to process the search task based on the load information, identifies each of the volumes, in which the data requested with the search task is stored, based on the table, and notifies the selected search server of the volume, and the search server processes the search task with respect to the volume.

### CLAIM OF PRIORITY

The present application claims priority from Japanese application P2004-286331 filed on Sep. 30, 2004, the content of which is hereby incorporated by reference into this application.

### BACKGROUND

This invention relates to a data archive system that stores data in a storage apparatus, in particular, a technique of searching the storage apparatus for desired data.

In recent years, in the United States of America, various regulations have been enacted in order to prevent illegal enterprise accounting, the leakage of personal information from electronic medical charts, and the like. An example of newly established regulations is the US Securities and Exchange Commission's Rule 17a-4. This rule stipulates obligations to take a countermeasure against tampering of stored electronic documents, to provide information without delay according to a request from a legal organization, and the like. In light of this backdrop, there arises the need for a data archive system that is capable of searching accumulated data for desired data.

In a data archive system, a large amount of data is stored. In order to provide information without delay according to a request from a legal organization, the data archive system needs to have a high-speed search unit. It is possible to realize the high-speed search unit by distributing the load of a search task.

Up to now, as a method of distributing the load of a search task, a technique has been known with which plural servers that perform search processing are prepared and are grouped with a load distribution apparatus (see, “HA8000-ie/Loadflowbal product catalog (page 1)”, Hitachi, Ltd., <URL: http://www.hitachi.co.jp/Prod/comp/OSD/pc/ha/prod/catalog/ielf0307.pdf>, for instance). The load distribution apparatus receives plural search tasks and distributes them to the different search servers.

### SUMMARY

According to the conventional load distribution apparatus, the plural search tasks are processed using the plural search servers and no consideration is given to processing of one search task using the plural search servers.

It is therefore an object of this invention to provide a technique of distributing one search task among plural servers and processing the search task using the plural servers.

In order to achieve the above object, this invention provides a data archive system, including: a storage apparatus including plural volumes in which data is stored; plural search servers which process a search task which requests a search for desired data; and a management server that includes a CPU, an interface, and a memory and manages the search servers, in which the management server has a table adapted to manage the data stored in the volumes, obtains load information concerning the search servers, selects each of the search servers, which is to process the search task based on the load information, identifies each of the volumes, in which the data requested with the search task is stored, based on the table, and notifies the selected search server of the volume, and the search server processes the search task with respect to the volume.

By parallelly processing one search task using plural search servers, it becomes possible to shorten a time required to process the search task.

### BRIEF DESCRIPTION OF THE DRAWINGS

The present invention can be appreciated by the description which follows in conjunction with the following figures, wherein:

FIG. 1 is a block diagram of a data archive system according to a first embodiment of this invention.

FIG. 2 is a construction diagram of a CPU load management table stored in a search task management server according to the first embodiment of this invention.

FIG. 3 is a construction diagram of an archive data management table stored in the search task management server according to the first embodiment of this invention.

FIG. 4 is a construction diagram of a search task management table stored in the search task management server according to the first embodiment of this invention.

FIG. 5 is a construction diagram of a target address management table stored in a storage management server according to the first embodiment of this invention.

FIG. 6 is a construction diagram of a storage capacity management table stored in the storage management server according to the first embodiment of this invention.

FIG. 7 is a flowchart of processing where the search task management server according to the first embodiment of this invention executes a CPU load monitor program.

FIG. 8 is a flowchart of archive processing performed in the data archive system according to the first embodiment of this invention.

FIG. 9 is a flowchart of search processing performed in the data archive system according to the first embodiment of this invention.

FIG. 10 is a flowchart of search task distribution processing performed by the search task management server according to the first embodiment of this invention.

FIG. 11 is a flowchart of allocation LU designation processing performed by the storage management server according to the first embodiment of this invention.

FIG. 12 is a construction diagram of an archive data management table stored in a search task management server according to a second embodiment of this invention.

FIG. 13 is a construction diagram of a search engine correspondence information storage table stored in the search task management server according to the second embodiment of this invention.

### DETAILED DESCRIPTION OF THE PREFERRED EMBODIMENTS

Hereinafter, embodiments of this invention will be described with reference to the accompanying drawings.

### First Embodiment

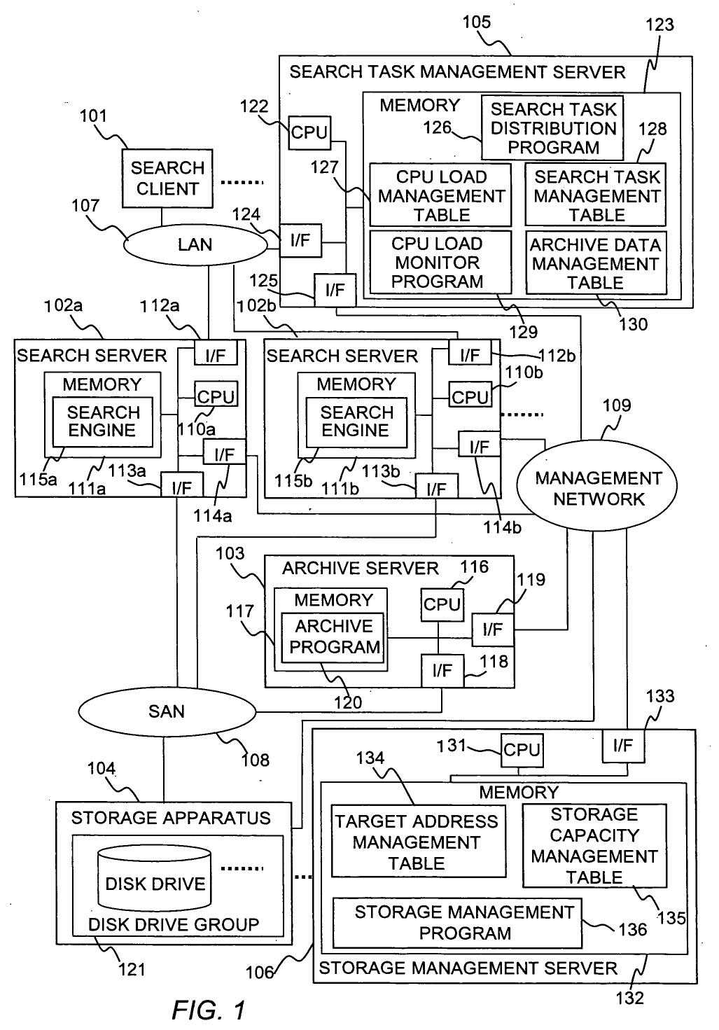

FIG. 1 is a block diagram of a data archive system according to a first embodiment of this invention.

First, the outline of this invention will be described.

The data archive system according to the embodiment of this invention includes a storage apparatus 104 having plural volumes in which data is stored, plural search servers 102a and 102b. that process a search task that requests a search for the data stored in the storage apparatus 104, and a search task management server 105 that manages the search server 102a and the like. The search task management server 105 stores management tables 127, 128, and 130 that manage the data stored in the volumes. Also, the search task management server 105 obtains load information concerning each of the search servers 102a and 102b and stores it in the CPU load management table 127. Then, based on the obtained load information, the search task management server 105 selects each search server that is to process the search task. Further, based on the archive data management table 130, the search task management server 105 identifies each volume in which data to be searched for with the search task is stored. Then, the search task management server 105 notifies the selected search server 102 of the identified volume. The selected search server 102 processes the search task with respect to the informed volume.

The data archive system according to the embodiment of this invention further includes an archive server 103 that stores the data in the volumes. The archive server 103 also stores the names of the data stored in the volume and attributes of the data stored in the volumes and the target addresses of the volumes, in which the data is stored, in the archive management data storage table 130.

Referring next to FIG. 1, the configuration of the data archive system according to the first embodiment of this invention will be described.

The data archive system according to this embodiment is configured by a search client 101, the search server 102a, the search server 102b, the archive server 103, the storage apparatus 104, the search task management server 105, a storage management server 106, a LAN 107, a SAN (Storage Area Network) 108, and a management network 109.

The search client 101, the search server 102a, the search server 102b, and the search task management server 105 are connected to each other through the LAN 107. Also, the search server 102a, the search server 102b, the archive server 103, and the storage apparatus 104 are connected to each other through the SAN 108. Further, the archive server 103, the storage management server 106, and the search task management server 105 are connected to each other through the management network 109.

The LAN 107 is, for instance, the Ethernet and transfers IP packets.

The SAN 108 is, for instance, an IP-SAN or an FC-SAN. The IP-SAN is an Ethernet SAN and an iSCSI protocol is used therein. On the other hand, the FC-SAN is a fibre channel SAN and a fibre channel protocol is used therein.

The management network 109 is, for instance, the Ethernet and transfers IP packets. The management network 109 is used to exchange management information between devices in the system.

It should be noted that in the data archive system according to the first embodiment, the LAN 107 and the management network 109 are each set as an independent network, although another configuration may be used instead, in which one network is commonly used.

The search client 101 is a computer that issues a search task. The search task is a request to search for desired data and is composed of an archive data and a search condition. The archive data is a identifier identifying archive data to be searched for. The search condition is a condition that narrows down the search and is, for instance, set as “search data created on and after 2003”. The search client 101 sends the search task to the search task management server 105 through the LAN 107. It should be noted that in the drawing, one search client 101 is illustrated, although the plural search clients 101 may be provided.

The search task management server 105 is a computer including a CPU 122, a memory 123, and interfaces 124 and 125. In the memory 123, a search task distribution program 126, the CPU load management table 127, the search task management table 128, a CPU load monitor program 129, and the archive data management table 130 are stored. It should be noted that the search task distribution program 126 and the CPU, load monitor program 129 are installed to the memory 123 through removable storage media, a network, or the like.

The interface 124 connects the search task management server 105 to the search client 101, the search server 102a, and the search server 102b through the LAN 107. The interface 125 connects the search task management server 105 to the search server 102a, the search server 102b, the archive server 103, the storage apparatus 104, and the storage management server 106 through the management network 109.

The CPU 122 performs various processings by executing the programs in the memory 123.

The CPU load monitor program 129 collects a CPU usage ratio from every search server 102 at predetermined timings (periodically, for instance). Then, the CPU load monitor program 129 stores the collected CPU usage ratio in the CPU load management table 127. Here, the CPU load monitor program 129 collects an MIB (Management Information Base) including the CPU usage ratio from the search server 102 using an SNMP (Simple Network Management Protocol), thereby collecting the CPU usage ratio. Alternatively, the CPU load monitor program 129 may collect the CPU usage ratio with another method.

The SNMP is a known technique standardized as RFC1157 (see <URL: http://www.ietf.org/rfc/rfc1157.txt>) by the IETF (Internet Engineering Task Force) and is a protocol used for communication of management information between a program that manages each device connected to a network and the device managed. It should be noted that in this embodiment, the program that manages the device is the CPU load monitor program 129 and the device to be managed is the search server 102.

Also, the MIB is a known technique, whose format has been standardized as RFC1155 (see <URL: http://www.ietf.org/rfc/rfc1155.txt>) by the IETF, and is management information communicated using the SNMP.

The search task distribution program 126 selects the search servers 102, whose CPU usage ratios are low, based on information stored in the CPU load management table 127. Then, the search task distribution program 126 requests the selected search servers 102 to process the search task.

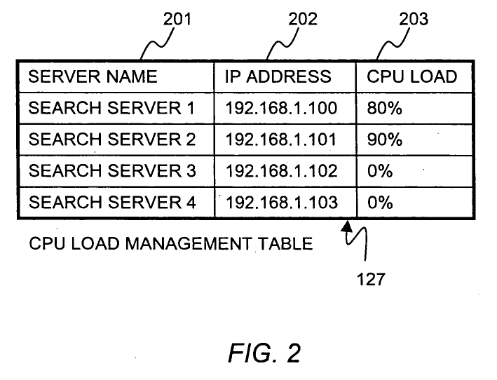

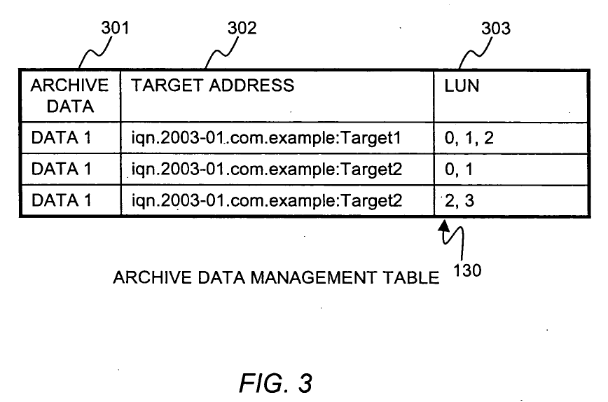

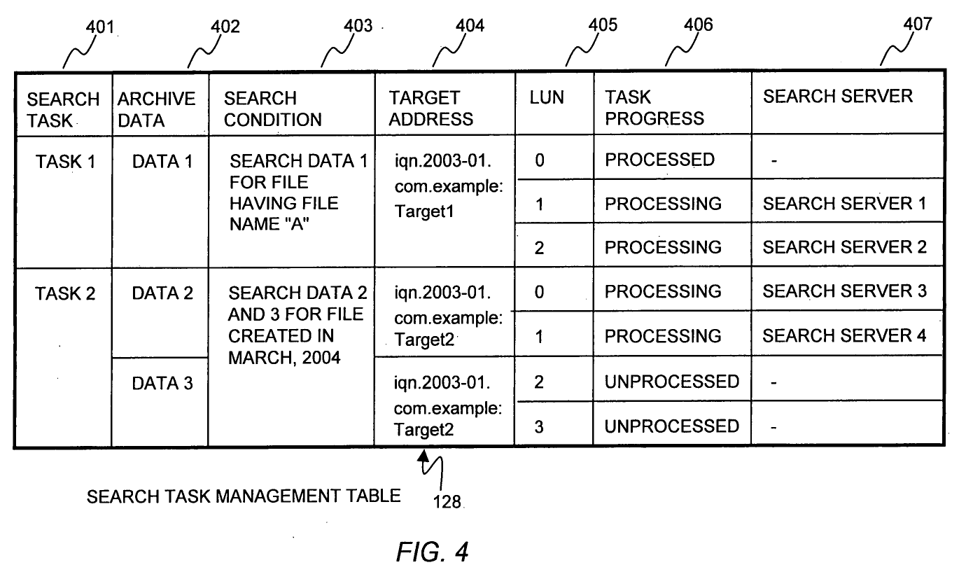

The CPU load management table 127 shows the CPU usage ratio of each search server 102, as shown in FIG. 2. The archive data management table 130 shows the storage location of each piece of archive data, as shown in FIG. 3. The search task management table 128 shows the search condition, task progress, and the like of each search task, as shown in FIG. 4.

The search server 102a is a computer including a CPU 110a54, a memory 111a, and interfaces 112a, 113a, and 114a. a search engine 115a is stored in the memory 111a. It should be noted that the search engine 115a is installed to the memory 111 through removable storage media or a network.

The interface 112a connects the search server 102a to the search client 101 and the search task management server 105 through the LAN 107. The interface 113a connects the search server 102a to the archive server 103 and the storage apparatus 104 through the SAN 108. The interface 114a connects The search server 102a to the search task management server 105 and the storage management server 106 through the management network 109.

The CPU 110a performs various kinds of processing by executing various programs in the memory 111a. The search engine 115a processes the search task.

It should be noted that the configuration of the search server 102b is the same as that of the search server 102a, so the description thereof will be omitted.

In the drawing, the two search servers 102 are illustrated, although three or more search servers may be provided. The data archive system according to this embodiment accelerates search processing by parallelly processing one search task using the plural search servers 102. In other words, in this embodiment, the plural search servers 102 are provided.

The archive server 103 is a computer including a CPU 116, a memory 117, and interfaces 118 and 119. In the memory 117, an archive program 120 is stored. It should be noted that the archive program 120 is installed to the memory 117 through removable storage media or a network.

The interface 118 connects the archive server 103 to the search server 102 and the storage apparatus 104 through the SAN 108. The interface 119 connects the archive server 103 to the search server 102 and the search task management server 105 through the management network 109.

The CPU 116 performs various kinds of processing by executing various programs in the memory 117. The archive program 120 creates archive data and then notifies the search task management server 105 of information about the created archive data.

Here, the archive data is data where many files have been collected. For instance, the archive data includes e-mails, electronic medical charts, video data, or document data. Alternatively, the archive data may be the access log of a Web server or a file server or the like.

The storage apparatus 104 is a storage apparatus having a disk drive group 121. The disk drive group 121 includes one or more disk drives. Each disk drive is, for instance, a magnetic disk drive, a magnetic tape drive, a DVD drive, or a CD drive and has a physical storage area. The storage apparatus 104 creates logical units (LUs) from the physical storage area of each disk drive. The LUs are logical storage areas provided for the search servers 102 and the archive server 103.

The storage management server 106 is a computer including a CPU 131, a memory 132, and an interface 133. In the memory 132, a target address management table 134, a storage capacity management table 135, and a storage management program 136 are stored. It should be noted that the storage management program 136 is installed to the memory 132 through removable storage media or a network.

The interface 133 connects the storage management server 106 to the search servers 102, the archive server 103, the storage apparatus 104, and the search task management server 105 through the management network 109.

The CPU 131 performs various kinds of processing by executing various programs in the memory 132.

The storage management program 136 changes the configuration of the storage apparatus 104. When changing the configuration of the storage apparatus 104, the storage management program 136 performs LU creation or deletion and further performs setting of the address of an interface provided for the storage apparatus 104. Also, after the changing of the configuration of the storage apparatus 104, the storage management program 136 stores the set address in the target address management table 134 and notifies the search task management server 105 of the free capacity and used capacity of the storage apparatus 104.

Aside from this, on receiving an inquiry about the address of an LU in which archive data is stored, the storage management program 136 notifies the search servers 102 of the address.

It should be noted that the search task management server 105 and the storage management server 106 are set as mutually different hardware devices, although they may be set as a single hardware device having the respective functions.

FIG. 2 is a construction diagram of the CPU load management table 127 stored in the search task management server 105 according to the first embodiment of this invention.

The CPU load management table 127 has an entry for each search server 102 provided in the data archive system and each entry is composed of a server name 201, an IP address 202, and a CPU load 203.

In each entry, the server name 201 is the unique identifier of the search server 102 corresponding to the entry, the IP address 202 is the IP address allocated to the interface 114 of the search server 102 corresponding to the entry, and the CPU load 203 is the usage ratio of the CPU 110 of the search server 102 corresponding to the entry.

The server name 201 and the IP address 202 are inputted by a system administrator. Also, as the CPU load 203, the CPU usage ratio included in the MIB is stored by the CPU load monitor program 129.

FIG. 3 is a construction diagram of the archive data management table 130 stored in the search task management server 105 according to the first embodiment of this invention.

The archive data management table 130 has an entry for each piece of archive data created by the archive server 103 and each entry is composed of archive data 301, a target address 302, and an LUN 303.

In each entry, the archive data 301 is the name that uniquely identifies archive data corresponding to the entry and the target address 302 is the address of the target allocated to an LU storing the archive data corresponding to the entry.

The target is an apparatus that is provided in the storage apparatus 104 and receives SCSI commands. The target may be a logical apparatus or may be a physical apparatus. The storage apparatus 104 may internally include plural targets.

Also, the target address is the unique identifier of the target. The target address is a WWN (World Wide Name) in the case of a fibre channel protocol and is an iSCSI name in the case of an iSCSI protocol.

Further, the target allocated to the LU is a target to which the archive server 103 and the search servers 102 send commands when reading/writing data from/into the LU. For instance, in this embodiment, data 1 is stored across three LUs and the address of its target is “iqn.2003-01.com.example:Target1”. Therefore, when reading the data 1, the search servers 102 send SCSI commands to the target address that is “iqn.2003-01.com.example:Target1”.

The LUs are allocated to any one of the targets of the storage apparatus 104 to which the LUs belong. It should be noted that it is possible to allocate plural LUs to one target, although it is impossible to allocate one LU to plural targets. This is determined by a rule of the SCSI.

In each entry, the LUN 303 is the identifier of each LU in which the archive data corresponding to the entry is stored. It should be noted that with the LUN 303, it is possible to identify each LU in each target. In other words, even when the same LUN 303 is used for different targets, it is possible to identify different storage locations of the archive data with the LUN 303.

FIG. 4 is a construction diagram of the search task management table 128 stored in the search task management server 105 according to the first embodiment of this invention.

The search task management table 128 has an entry for each search task and each entry is composed of a search task 401, archive data 402, a search condition 403, a target address 404, an LUN 405, a task progress 406, and a search server 407.

In each entry, the search task 401 is the identifier identifying a search task corresponding to the entry, the archive data 402 is the name of each piece of archive data to be searched for with the search task corresponding to the entry, and the search condition 403 is a search condition for the archive data to be searched for with the search task corresponding to the entry. It should be noted that an archive data entry is created for each piece of archive data to be searched for with the search task.

In each entry, the target address 404 is the address of a target to which each LU storing the archive data to be searched for with the search task corresponding to the entry is allocated. It should be noted that a target address entry is created for each archive data entry.

In each entry, the LUN 405 is the identifier of each LU storing the archive data to be searched for with the search task corresponding to the entry. It should be noted that as regards the LUN 405, an LUN entry is created for each LUN value. For instance, the data 1 to be processed with a task 1 is stored across three LUs whose LUN values are “0”, “1”, and “2”. Therefore, three LUN entries are created in the LUN 405 for the task 1.

In each entry, the task progress 406 is the progress of a search with respect to each LU corresponding to the entry. It should be noted that a task progress entry is created for each LUN entry. Also, the task progress 406 is set as “processed” when search processing with respect to its corresponding LU is completed, is set as “under task processing” when the search processing is currently performed, and is set as “unprocessed” when the search processing has not been yet performed.

In each entry, the search server 407 is the server name of the search server 102 that is currently performing search processing with respect to each LU corresponding to the entry. In other words, a server name is stored as the search server 407 only when the task progress 406 is set as “under task processing” and no server name is stored in other cases. It should be noted that a search server entry is created for each LUN entry.

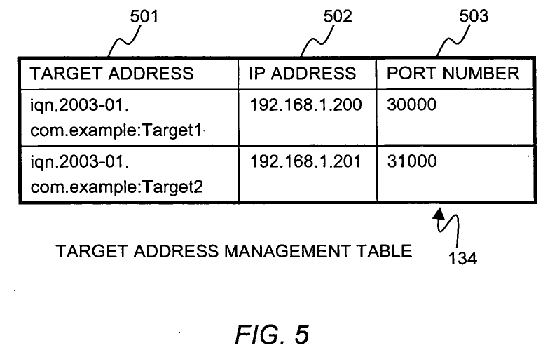

FIG. 5 is a construction diagram of the target address management table 134 stored in the storage management server 106 according to the first embodiment of this invention.

The target address management table 134 has an entry for each target in the storage apparatus 104 and each entry is composed of a target-address 501, an IP address 502, and a port number 503.

In each entry, the target address 501 is the address of a target corresponding to the entry, the IP address 502 is an IP address for accessing the target corresponding to the entry, and the port number 503 is a TCP port number for accessing the target corresponding to the entry.

When accessing the target using an iSCSI protocol, the search servers 102 and the archive server 103 use the IP address 502 and the port number 503. On the other hand, when accessing the target using a fibre channel protocol, the search servers 102 and the archive server 103 do not use the IP address 502 and the port number 503. In other words, the target address management table 134 is required when the SAN 108 is an IP-SAN but is not required when the SAN 108 is an FC-SAN.

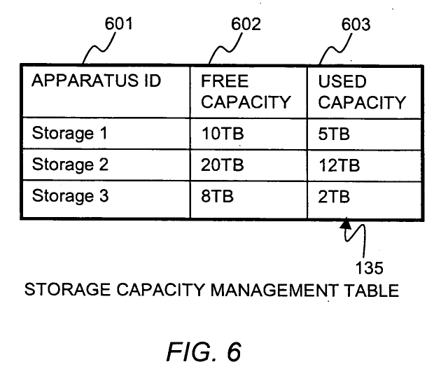

FIG. 6 is a construction diagram of the storage capacity management table 135 stored in the storage management server 106 according to the first embodiment of this invention.

The storage capacity management table 135 has an entry for each storage apparatus 104 provided in the data archive system and each entry is composed of an apparatus ID 601, a free capacity 602, and a used capacity 603.

In each entry, the apparatus ID 601 is the identifier that uniquely identifies the storage apparatus 104 corresponding to the entry, the free capacity 602 is the amount of data storable in the storage apparatus 104, and the used capacity 603 is the amount of data that the storage apparatus 104 corresponding to the entry has already stored.

Next, processing in the data archive system according to the first embodiment of this invention will be described.

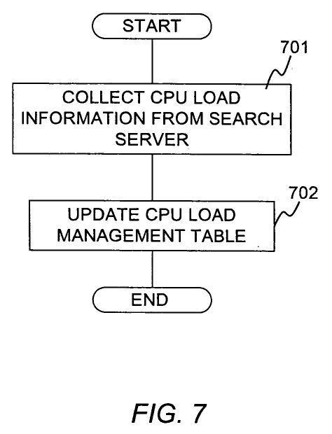

FIG. 7 is a flowchart of processing of the CPU load monitor program 129 according to the first embodiment of this invention that is executed by the search task management server 105.

First, the IP address allocated to the interface 114 of each search server 102 is extracted from the CPU load management table 127 and an MIB including CPU load information is collected from every search server 102 using the extracted IP address (701).

Then, the CPU load 203 in the CPU load management table 127 is updated according to the collected CPU load information (702).

The search task management server 105 periodically executes the processing described above. The intervals, at which the processing is performed, are set by the administrator of the system. This processing may be executed at regular intervals or may be executed at irregular intervals when necessary.

Through the CPU load monitor processing described above, the search task management server 105 collects and monitors the CPU load of every search server 102.

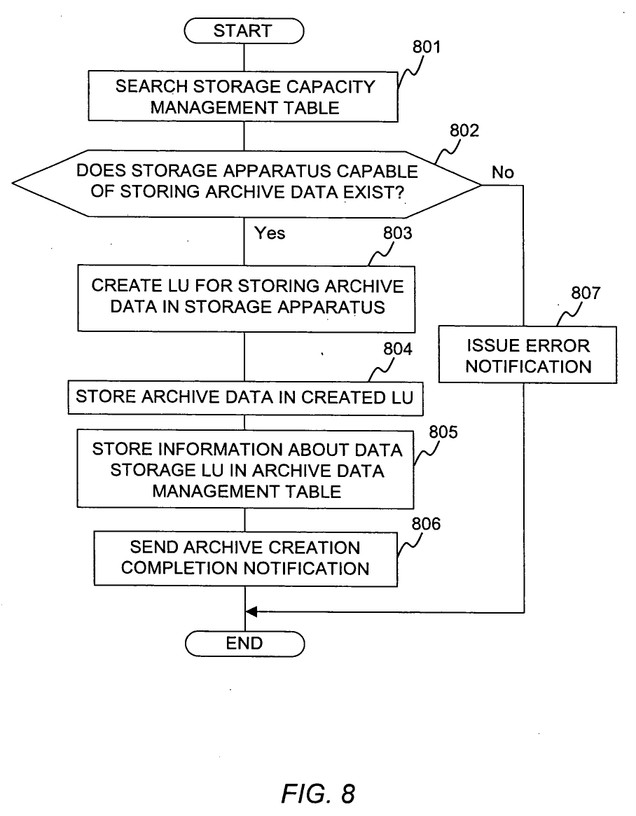

FIG. 8 is a flowchart of archive processing according to the first embodiment of this invention.

On receiving an archive creation request from a user, the archive server 103 executes the archive program 120. The archive creation request includes data to be archived and an archive file name.

Alternatively, the archive server 103 may execute the archive program 120 periodically based on an archive creation schedule created by the user. The archive creation schedule is, for instance, a setting where “access logs are collected from Web servers and archive data is created at 0 a.m. every day”.

First, the archive server 103 starts the archive program 120 and the total of data sizes of received data to be archived is computed. Next, the archive server 103 searches the storage capacity management table 135 for the storage apparatuses 104 having free capacities that are equal to or more than the computed total data size (801).

Next, the archive server 103 judges whether there exist any storage apparatuses 104 that are capable of storing the data to be archived (802). When there exist any storage apparatuses 104 having free capacities that are equal to or more than the total data size of the data to be archived, it is possible to store the archive data in the storage apparatuses 104.

When there exists no storage apparatus 104 that is capable of storing the archive data, the archive server 103 issues an error notification to the administrator (807). Then, the archive program 120 is ended.

On the other hand, when there exist any storage apparatuses 104 that are capable of storing the archive data, the archive server 103 then selects the storage apparatus 104 (target storage apparatus) having the largest free capacity from among the storage apparatuses 104 found as a result of the search in the step 801. It should be noted that the archive server 103 may select the target storage apparatus 104 with another method. For instance, the storage apparatus 104 having the smallest free capacity may be selected from among the storage apparatuses 104 found as a result of the search in the step 801 and having free capacities minimum but enough to store the archive data.

The archive server 103 requests the storage management server 106 to create an LU in the target storage apparatus 104. It is necessary that the LU to be created has a capacity corresponding to the total data size of the data to be archived.

On receiving the LU creation request, the storage management server 106 requests the target storage apparatus 104 to create the LU. The LU creation request includes the capacity of the LU to be created.

It should be noted that the storage management server 106 may issue a request to create plural LUs. In this case, the data to be archived is stored across the plural LUs. For instance, when the disk drive of the target storage apparatus 104 is an optical media drive such as a DVD drive, one LU corresponds to one DVD disk. The capacity of such an optical medium is determined in advance. Therefore, when the size of the data to be archived is large, the storage management server 106 issues a request to create plural LUs.

Supposing that the target storage apparatus 104 is a storage apparatus that stores data on DVDs as an example, the maximum amount of data storable on a DVD disk is 4.7 gigabytes. When the total data size of the data to be archived is 100 gigabytes, for instance, the archive server 103 requests the target storage apparatus 104 to create 22 LUs.

Then, on receiving the LU creation request, the target storage apparatus 104 creates one or more LUs for a designated capacity (803). Then, the target storage apparatus 104 allocates each created LU to a target in the storage apparatus 104. It should be noted that when the target storage apparatus 104 possesses plural targets, it allocates the created LU to one target selected arbitrarily.

Next, the target storage apparatus 104 allocates an LUN to each created LU. In addition, the target storage apparatus 104 sends the address of the target and the LUN allocated to the created LU to the storage management server 106.

In response to this, the storage management server 106 updates the storage capacity management table 135. More specifically, the storage management server 106 extracts an entry corresponding to the target storage apparatus 104 from the storage capacity management table 135. Next, the storage management server 106 increments the value of the free capacity 602 in the extracted entry by the capacity of the LU created in the step 803. In addition, the storage management server 106 decrements the value of the used capacity 603 in the same entry by the capacity of the LU created in the step 803.

Next, the storage management server 106 notifies the archive server 103 of the target address and the LUN of the LU created in the step 803.

The archive server 103 accesses the created LU using the notified target address and LUN. Then, the archive server 103 creates archive data from the data to be archived and stores the created archive data in the LU that it accesses (804).

Here, when the SAN 108 is an IP-SAN, in order to access the created LU, the archive server 103 needs to know the IP address and the TCP port number of the target. Thus, the archive server 103 sends the address of the target to the storage management server 106, thereby requesting the IP address and the TCP port number.

On receiving the request, the storage management server 106 selects an entry matching the received target address from the target address management table 134. Then, the storage management server 106 sends the IP address 502 and the port number 503 in the selected entry to the archive server 103.

The archive server 103 accesses the target using the received IP address 502 and port number 503. Then, the archive server 103 accesses the LU created in the step 803. Next, the archive server 103 creates archive data from the data to be archived and stores the created archive data in the LU that it accesses (804).

Next, the archive server 103 sends information about each data storage LU to the search task management server 105. The information about the data storage LU is the archive data of the stored archive data, the LUN of the storage LU, and the address of the target to which the storage LU has been allocated. Then, the search task management server 105 stores the received information about the data storage LU in the archive data management table 130 (805). More specifically, the search task management server 105 extracts the archive data, the target address, and the LUN from the received data storage LU information. Then, the search task management server 105 creates a new entry in the archive data management table 130 and stores the extracted archive data, target address, and LUN as the archive data 301, the target address 302, and the LUN 303 in the created entry.

Then, the search task management server 105 sends a storage completion notification to the archive server 103.

Following this, on receiving the storage completion notification, the archive server 103 sends an archive creation completion notification to the user from which the archive creation request was received (806). Then, on receiving the archive creation completion notification, the archive server 103 ends the archive program 120.

In the manner described above, on receiving an archive creation request, the archive server 103 creates archive data and stores it in the storage apparatus 104.

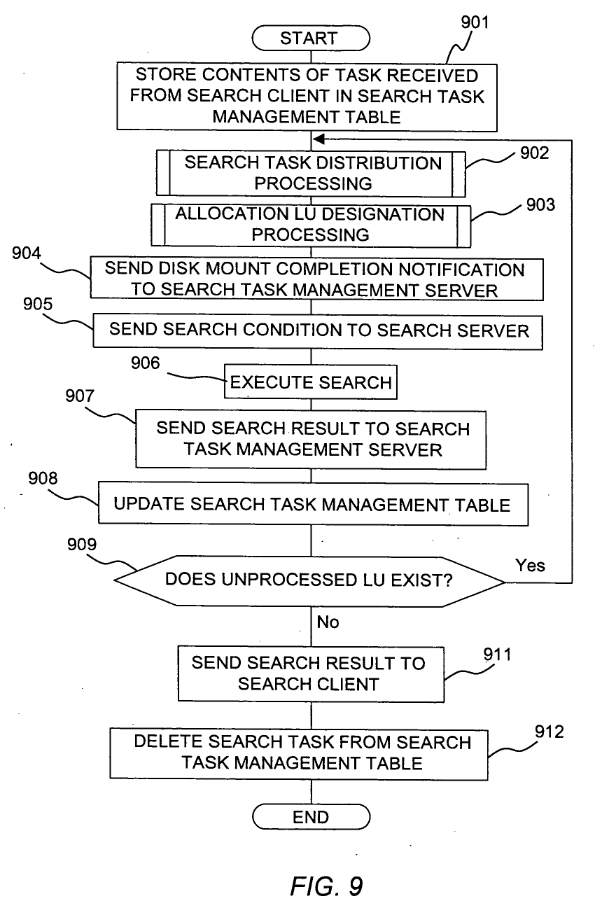

FIG. 9 is a flowchart of search processing according to the first embodiment of this invention.

When the search client 101 sends a search task to the search task management server 105, the data archive system starts the search processing. In the search task, the archive data and the search condition of data to be searched for are included.

On receiving the search task, the search task management server 105 stores the contents of the search task in the search task management table 128 (901).

More specifically, the search task management server 105 stores the archive data in the search task as the archive data 402 and stores the search condition in the search task as the search condition 403. Next, the search task management server 105 gives a name to the search task using a time, at which the search task was received, or the like. For instance, the search task management server 105 gives a name “task-2004/07/01-13:02:11” using the time at which the search task was received. Then, the search task management server 105 stores the name given to the search task as the search task 401.

Next, the search task management server 105 selects an entry, whose archive data 301 matches the archive data in the received search task, from the archive data management table 130. Then, the search task management server 105 extracts the target address 302 and the LUN 303 from the selected entry. Then, the search task management server 105 stores the extracted target address and LUN in the search task management table 128. More specifically, the extracted target address is stored as the target address 404 and the extracted LUN is stored as the LUN 405. It should be noted that when plural LUN values have been extracted, the search task management server 105 creates an entry for each extracted LUN value as the LUN 405 and stores each extracted LUN value in one entry.

Next, the search task management server 105 stores status information “unprocessed” as the task progress 406. It should be noted that when there are plural task progress entries corresponding to the received search task, the search task management server 105 stores “unprocessed” in every task progress entry.

In the manner described above, the search task management server 105 stores the contents of the received search task in the search task management table 128.

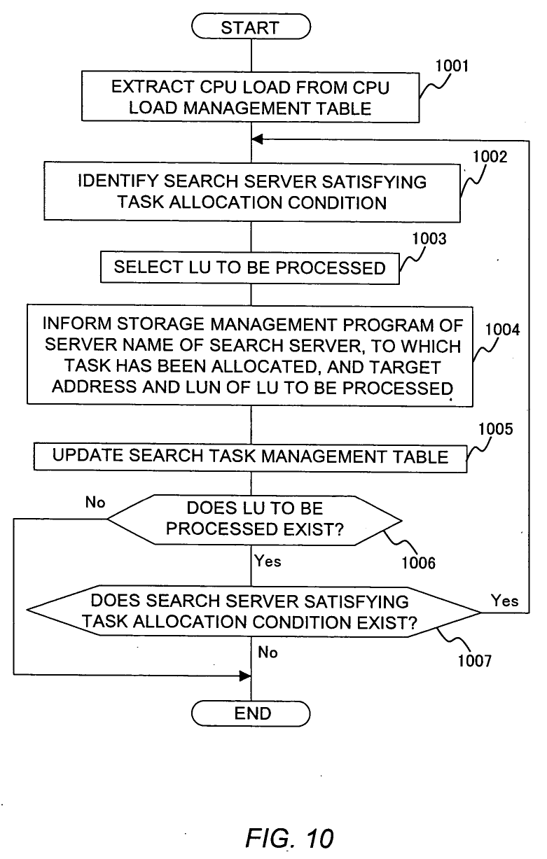

Next, the search task management server 105 performs search task distribution processing which will be described in detail with reference to FIG. 10 (902).

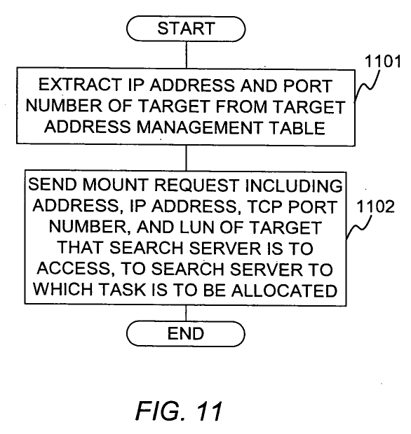

Next, the storage management server 106 performs allocation LU designation processing which will be described in detail with reference to FIG. 11 (903). It should be noted that in the allocation LU designation processing, the storage management server 106 sends a mount request to the search server 102.

On receiving the mount request, the search server 102 mounts an LU, in which the archive data to be searched for is stored, using information included in the mount request. When the SAN 108 is an FC-SAN, the mount request includes a target address and an LUN. On the other hand, when the SAN 108 is an IP-SAN, the mount request includes a target address, an LUN, and the IP address and the TCP port number of a target.

Here, the mount is an operation where a disk drive and a computer are connected to each other in terms of software, thereby making it possible for the computer to access the disk drive. In this embodiment, the computer is the search server 102 and the disk drive is the storage apparatus 104.

Then, when the mount is completed, the search server 102 sends a mount completion notification to the search task management server 105 (904). It should be noted that the mount completion notification includes the target address and the LUN of the mounted LU.

Then, on receiving the mount completion notification, the search task management server 105 sends a search condition to the search server 102 that has sent the mount completion notification (905). More specifically, the search task management server 105 selects an entry, whose target address 404 and LUN 405 match the target address and LUN included in the mount completion notification, from the search task management table 128. Next, the search task management server 105 extracts the search condition 403 from the selected entry. Then, the search task management server 105 sends the extracted search condition 403 as the search condition to the search server 102 that has sent the mount completion notification.

Next, on receiving the search condition, the search server 102 searches the LU mounted in the step 904 for archive data satisfying the search condition (906).

Following this, when the search is ended, the search server 102 sends a search result to the search task management server 105 (907). The search result is, for instance, the file name of a file satisfying the search condition.

Then, on receiving the search result, the search task management server 105 updates the search task management table 128 (908). More specifically, the search task management server 105 deletes the server name (search server 407) of the search server 102 having sent the search result from the search task management table 128. In addition, the search task management server 105 changes the task progress 406 corresponding to the entry where the server name (search server 407) is deleted from the search task management table 128, from “under task processing” to “processed”.

Next, the search task management server 105 judges whether there exist any LUs whose search processing has not been yet completed (909). More specifically, the search task management server 105 judges whether any task progresses 406 in the search task management table 128 are set as “unprocessed”.

When any unprocessed LUs exist, the processing returns to the step 902 and the search processing is repeated.

On the other hand, when no unprocessed LU exists, the search task management server 105 sends the search result received in the step 907 to the search client 101 (911).

Then, the search task management server 105 deletes an entry corresponding to the search task, whose search result was sent, from the search task management table 128 (912). Thus, the search processing is ended.

In the manner described above, it is possible to search for archive data swiftly and efficiently in the data archive system according to this embodiment.

FIG. 10 is a flowchart of the search task distribution processing according to the first embodiment of this invention, which is performed by the search task management server 105.

First, the search task management server 105 extracts the CPU load 203 of every search server 102 from the CPU load management table 127 (1001).

Next, the search task management server 105 identifies each search server 102 satisfying a search task allocation condition (1002). Here, the search task allocation condition is, for instance, a threshold value set for the CPU load by the administrator of the data archive system. More specifically, for instance, the search task allocation condition means “allocation of a search task to each search server whose CPU load is 50% or less”.

Next, the search task management server 105 selects a search server 102, whose CPU load 203 is the smallest, from among the search servers 102 satisfying the search task allocation condition. Hereinafter, the selected search server 102 will be referred to as the search server 102. Here, when there exists no search server 102 satisfying the search task allocation condition, the processing waits in the step 1002 for any search servers 102 that satisfy the condition.

Next, the search task management server 105 selects an LU (processing target LU) for which the search server 102 is to perform search processing (1003). More specifically, the top entry among entries, whose task progresses 406 are set as “unprocessed”, is selected from the search task management table 128. Then, the search task management server 105 sets an LU corresponding to the selected entry as the processing target LU.

Next, the search task management server 105 notifies the storage management server 132 of the server name of the search server 102, the target address 404 of the processing target LU, and the LUN 405 of the processing target LU (1004).

Next, the search task management server 105 updates the search task management table 128 (1005). More specifically, the search task management server 105 selects an entry corresponding to the processing target LU from the search task management table 128. Then, the search task management server 105 stores the server name of the search server 102 as the search server 407 in the selected entry. In addition, the search task management server 105 changes the task progress 406 in the selected entry from “unprocessed” to “under task processing”.

Next, the search task management server 105 judges whether another processing target LU exists (1006). More specifically, the search task management server 105 judges whether an entry, in which the task progress 406 is set as “unprocessed”, exists in the search task management table 128.

When another processing target LU does not exist, the search task distribution processing is ended.

On the other hand, when another processing target LU exists, it is judged whether any other search servers 102 satisfying the search task allocation condition exist (1007).

When no other search servers 102 exist, the search task distribution processing is ended.

On the other hand, when the other search server 102 exists, the processing returns to the step 1002 and the search task distribution processing is repeated.

It should be noted that it is possible to limit the number of times the processing is repeated. This is because if the number of times is not limited, there is a possibility that processing target LUs are allocated to all search servers satisfying the search task allocation condition in succession. In this case, even when the search client 101 issued a new search task, no search server satisfies the search task allocation condition and therefore it is impossible to execute the new search task before the search task issued previously is ended.

In the manner described above, the search task management server 105 selects search servers 102, whose CPU loads are low, by referring to the CPU load management table 127, so it is possible to execute a search task with efficiency using the search servers 102.

FIG. 11 is a flowchart of the allocation LU designation processing performed by the storage management server 106 according to the first embodiment of this invention.

On receiving the notification issued from the search task management server 105 in the step 1004 of the search task distribution processing shown in FIG. 10, the storage management server 106 starts the allocation LU designation processing.

First, the storage management server 106 extracts the IP address and the TCP port number of the target that is to access the processing target LU from the target address management table 134 (1101). More specifically, the storage management server 106 selects an entry, whose target address 501 matches the target address 404 notified in the step 1004 of the search task distribution processing, from the target address management table 134. Then, the storage management server 106 extracts the IP address 502 and the port number 503 from the selected entry.

It should be noted that when the SAN 108 is an FC-SAN, it is possible to skip the step 1101. This is because it is possible for the search server 102 to mount the processing target LU only with the target address (WWN) of the target and the LUN of the processing target LU.

Next, the storage management server 106 sends a mount request to the search server 102 (1102). The mount request includes the address, IP address, and TCP port number of the target that is to access the processing target LU and the LUN of the processing target LU. It should be noted that the target address in the mount request is the target address 404 notified in the search task distribution processing, the IP address in the mount request is the extracted IP address 502, the TCP port number in the mount request is the extracted port number 503, and the LUN in the mount request is the LUN 405 notified in the search task distribution processing.

### Second Embodiment

A data archive system according to a second embodiment of this invention includes plural archive servers. In addition, search servers include search engines having different functions.

Alternatively, the data archive system according to the second embodiment may be configured in the same manner as in the first embodiment. In this case, however, one archive server 103 may include the plural archive programs 120. The processing of the data archive system according to the second embodiment is the same as that of the data archive system according to the first embodiment except for points to be described later and the repetitive description will be omitted.

The multiple archive programs 120 compress original data at the time of creation of archive data. Also, the archive programs 120 use various data compression methods according to the kinds thereof and there is also an archive program that adopts a unique compression method. Further, each search server 102 is only capable of searching for archive data compressed with a compression method that it supports.

Therefore, in the data archive system where the plural archive programs 120 create archive data in different compression systems, it is impossible to search for every piece of archive data using only one kind of search server 102, in other words, it is impossible to perform archive data search with the configuration of the data archive system according to the first embodiment.

In order to solve this problem, in the second embodiment, the names of archive programs that created archive data are stored in the archive data management table 130. Also, the search task management server 105 stores a search engine correspondence information storage table in the memory 123. The search engine correspondence information storage table shows correspondences between the archive program 120 and each search server.

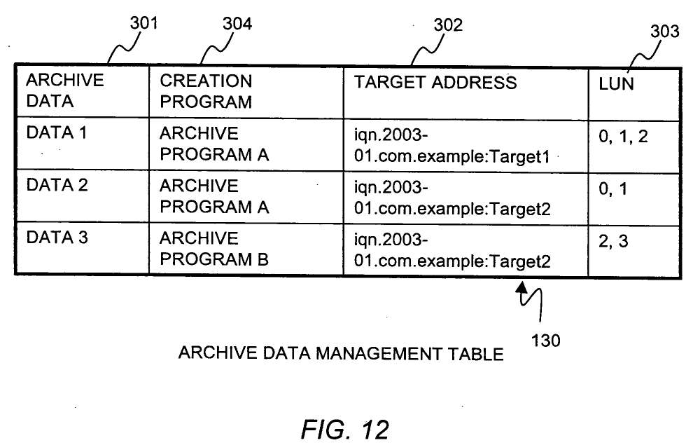

FIG. 12 is a construction diagram of the archive data management table 130 stored in the search task management server 105 according to the second embodiment of this invention.

The archive data management table 130 according to the second embodiment has entries that are each composed of the archive data 301, a creation program 304, the target address 302, and the LUN 303. It should be noted that the archive data 301, the target address 302, and the LUN 303 are the same as those in the archive data management table shown in FIG. 3 according to the first embodiment, so the description thereof will be omitted.

In each entry, the creation program 304 is the program name of the archive program 120 that created archive data corresponding to the entry.

Also, the second embodiment differs from the first embodiment in the step 805 of the archive processing shown in FIG. 8. More specifically, the search task management server 105 stores the name of the archive program 120 having created the archive data in the step 804 along with the information about the data storage LU in the archive data management table 130 (805).

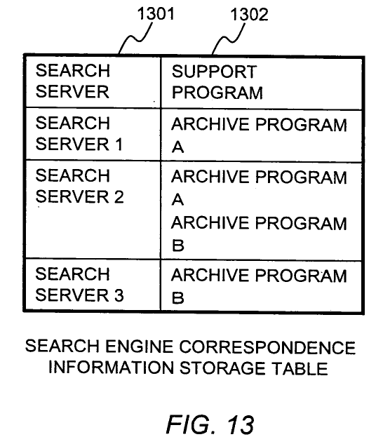

FIG. 13 is a construction diagram of the search engine correspondence information storage table stored in the search task management server 105 according to the second embodiment of this invention.

The search engine correspondence information storage table has entries that are each composed of a search server 1301 and a support program 1302.

In each entry, the search server 1301 is the unique identifier of a search server 102 corresponding to the entry and the support program 1302 is the name of each archive program 120 that the search server 102 corresponding to the entry supports. The search engine correspondence information storage table is inputted by the administrator of the data archive system.

It should be noted that instead of the search engine correspondence information storage table, a construction may be used in which the support program 1302 is stored in the CPU load management table 127.

In the data archive system according to the second embodiment, a condition “support for the archive program 120 having created archive data” is added to the search task allocation condition used in the step 1002 of the search task distribution processing shown in FIG. 10.

Here, processing in the step 1002 of the search task distribution processing shown in FIG. 10 according to the second embodiment will be described.

The search task management server 105 identifies each search server 102 that satisfies the search task allocation condition (1002).

More specifically, first, the search task management server 105 extracts, from the archive data management table 130, the creation program 304 in an entry corresponding to the archive data 120 to be searched for. Next, the search task management server 105 extracts every search server 1301, whose support program 1302 matches the extracted creation program 304, from the search engine correspondence information storage table.

Then, the search task management server 105 identifies each search server 102 that satisfies another search task allocation condition (CPU load threshold value, for instance) from among the extracted search servers 1301.

Following this, the processing in the step 1003 and its subsequent steps of the search task distribution processing shown in FIG. 10 is performed in the same manner as in the first embodiment.

As described above, in the data archive system according to the second embodiment, even when archive data has been created by different kinds of archive programs 120, it is possible to automatically allocate the search servers 102 according to the archive programs 120 that they support.

This invention is applicable to a data archive system where data is stored in a storage apparatus and is suitably applied to a system where a large amount of data is stored across plural LUs of a storage apparatus.

While the present invention has been described in detail and pictorially in the accompanying drawings, the present invention is not limited to such detail but covers various obvious modifications and equivalent arrangements, which fall within the purview of the appended claims.

What is claimed is:

1. A data archive system, comprising:
a storage apparatus comprising a plurality of volumes in which data is stored;
a plurality of search servers which process a search task which requests a search for the data stored in the storage apparatus; and
a management server which manages the search servers, wherein the management server:
holds management information adapted to manage the data stored in the volumes;
obtains load information concerning the search servers;
selects the search servers, which is to process the search task based on the obtained load information;
identifies a volume, in which the data to be searched for with the search task is stored, based on the management information;
notifies the selected search server of the identified volume; and
processes the search task with respect to the notified volume using the selected search server.

2. The data archive system according to Claim. 1, wherein when the data to be searched for is stored across the plurality of volumes, the search server that is to process the search task is selected with respect to each volume in which the data to be searched for is stored.

3. The data archive system according to claim 1, wherein in the management information, names of the data stored in the volumes and address information concerning the volumes, in which the data is stored, are stored in association with each other.

4. The data archive system according to claim 1, further comprising:
an archive server which stores the data in the volumes and stores data names of the data and address information concerning the volumes, in which the data is stored, in the management information.

5. The data archive system according to claim 1, further comprising:
an archive server which stores the data in the volumes and stores data names and attribute of the data and address information concerning the volumes, in which the data is stored, in the management information,
wherein the management server selects the search server that is to process the search task based on the load information and the management information.

6. A data search method used for a data archive system that comprises a storage apparatus comprising a plurality of volumes in which data is stored, a plurality of search servers which process a search task which requests a search for the data stored in the storage apparatus, and a management server which manages the search servers,
the data search method comprising:
holding management information adapted to manage the data stored in the volumes;
obtaining load information concerning the search servers;
selecting each of the search servers, which is to process the search task based on the obtained load information;
identifying a volume, in which the data to be searched for with the search task is stored, based on the management information;
notifying the selected search server of the identified volume; and
processing the search task with respect to the notified volume using the selected search server.

7. The data search method according to claim 6, wherein when the data to be searched for is stored across the plurality of volumes, the search server that is to process the search task is selected with respect to each volume in which the data to be searched for is stored.

8. The data search method according to claim 6, wherein in the management information, data names of the data stored in the volumes and address information concerning the volumes, in which the data is stored, are stored in association with each other.

9. A management server for managing a plurality of search servers that process a search task requesting a search for data stored in a storage apparatus comprising a plurality of volumes, comprising:
a CPU;
an interface; and
a memory,
wherein the management server holds management information adapted to manage the data stored in the volumes, obtains load information concerning the search servers, selects the search servers, which is to process the search task based on the obtained load information, identifies a volume, in which the data to be searched for with the search task is stored, based on the management information, and notifies the selected search server of the identified volume.

10. The management server according to claim 9, selecting the search server that is to process the search task with respect to each volume in which the data to be searched for is stored, when the data to be searched for is stored across the plurality of volumes, the management server.
